(19) United States
(12) Patent Application Publication
(10) Pub. No.: US 2022/0284472 A1
(43) Pub. Date: Sep. 8, 2022

(54) METHODS AND APPARATUSES, ELECTRONIC DEVICES, AND STORAGE MEDIA FOR INFORMATION DELIVERY

(71) Applicant: Beijing Sensetime Technology Development Co., Ltd., Beijing (CN)

(72) Inventors: Xinyi ZHAO, Beijing (CN); Meng YU, Beijing (CN)

(21) Appl. No.: 17/825,221

(22) Filed: May 26, 2022

Related U.S. Application Data
(63) Continuation of application No. PCT/CN2020/121588, filed on Oct. 16, 2020.

(30) Foreign Application Priority Data
Jan. 17, 2020 (CN) 202010051471.0

(51) Int. Cl. G06Q 30/02; G06V 40/16

(52) U.S. Cl. CPC G06Q 30/0251; G06V 40/161

(57) ABSTRACT

Methods, apparatuses, electronic devices, and storage media for information delivery are provided. In one aspect, a method includes: acquiring a face image of at least one delivery object, determining a face attribute according to the face image, a delivery object corresponding to a set of face attributes, obtaining target delivery information for the face attribute, and delivering the target delivery information for the face attribute.

### CROSS-REFERENCE TO RELATED APPLICATIONS

The present disclosure is a continuation application of International Application No. PCT/CN2020/121588 filed on Oct. 16, 2020, which claims priority to Chinese patent application No. 202010051471.0 filed on Jan. 17, 2020, both of which are incorporated herein by reference in their entireties.

### TECHNICAL FIELD

The present disclosure relates to the field of computer vision technology, and in particular to methods and apparatuses, electronic devices, and storage media for information delivery.

### BACKGROUND

With the continuous development of science and technology, a variety of advertising delivery methods have emerged in the advertising media industry. For example, terminals may be provided in public places such as shopping malls, bus stations and airports, and advertisements may be played on the terminals to push relevant information.

### SUMMARY

Embodiments of the present disclosure provide a computer-implemented method for information delivery including: acquiring a face image of at least one delivery object; determining a face attribute according to the face image, where a delivery object corresponds to a set of face attributes; obtaining target delivery information for the face attribute; and delivering the target delivery information for the face attribute.

In an embodiment, the face attribute includes a face identifier, and obtaining the target delivery information for the face attribute includes: determining to-be-delivered information and historical delivery information for the face identifier; and obtaining, from the to-be-delivered information, information other than the historical delivery information, at least part of which is used as the target delivery information for the face identifier.

In an embodiment, the face attribute includes a face identifier, and determining the face attribute according to the face image includes: obtaining, from a face image library a reference face image with a highest similarity to a first face image involved in the face image; and if a similarity between the first face image and the reference face image is greater than a threshold, determining an identifier corresponding to the reference face image as the face identifier corresponding to the first face image.

In an embodiment, the method further includes: if the similarity between the first face image and the reference face image is no greater than the threshold, generating the face identifier corresponding to the first face image, and storing the face identifier corresponding to the first face image in the face image library in association with the first face image.

In an embodiment, the method further includes: after delivering the target delivery information for the face attribute, determining and storing the target delivery information for the face attribute as historical delivery information tier the face attribute.

In an embodiment, the at least one delivery object includes a plurality of delivery objects with at least two delivery objects corresponding to different face attributes, and the method includes: obtaining target delivery information for face attributes associated with the plurality of delivery objects; determining priorities of the plurality of delivery objects based on a plurality of sets of face attributes associated with the plurality of delivery objects; and delivering the target delivery information for the plurality of delivery objects, including one of: delivering the target delivery information for the plurality of delivery objects in sequence or in batches based on the priorities of the plurality of delivery objects, or delivering target delivery information for at least one of the plurality of delivery objects, where each of the at least one of the plurality of delivery objects has a higher priority than each of one or more other delivery objects among the plurality of delivery objects.

In an embodiment, the face attribute includes at least one of a gender, an age, or an expression, and the method further includes at least one of if the face attribute includes the gender, determining that a female delivery object has a higher priority than a male delivery object, if the face attribute includes the age, determining that a delivery object with a younger age has a higher priority than a delivery object with an older age, or if the face attribute includes the expression, determining that a delivery object with a positive expression has a higher priority than a delivery object with a negative expression.

In an embodiment, the face attribute includes at least one of a total amount of payments or a number of payments, and the method further includes at least one of: if the face attribute includes the total amount of payments, determining that the at least one delivery object has a priority positively correlated with the total amount of payments, or if the face attribute includes the number of payments, determining that the at least one delivery object has a priority positively correlated with the number of payments.

Embodiments of the present disclosure provide an electronic device including at least one processor; at least one memory; and a communication bus configured to implement connection and communication between the at least one processor and the at least one memory, where the at least one memory is coupled to the at least one processor and stores programming instructions for execution by the at least one processor to perform operations including: acquiring a face image of at least one delivery object; determining a face attribute according to the face image, where a delivery object corresponds to a set of face attributes; obtaining target delivery information for the face attribute; and delivering the target delivery information for the face attribute.

In an embodiment, the face attribute includes a face identifier, and obtaining the target delivery information for the face attribute includes: determining to-be-delivered information and historical delivery information for the face identifier; and obtaining, from the to-be-delivered information, information other than the historical delivery information, at least part of which is used as the target delivery information for the face identifier.

In an embodiment, the face attribute includes a face identifier, and determining the face attribute according to the face image includes: obtaining, from a face image library, a reference face image with a highest similarity to a first face image involved in the face image; and if a similarity between the first face image and the reference face image is greater than a threshold, determining an identifier corresponding to the reference face image as the face identifier corresponding to the first face image.

In an embodiment, the operations further include: if the similarity between the first face image and the reference face image is no greater than the threshold, generating the face identifier corresponding to the first face image, and storing the face identifier corresponding to the first face image in the face image library in association with the first face image.

In an embodiment, the operations further include: after delivering the target delivery information for the face attribute, determining and storing the target delivery information for the face attribute as historical delivery information for the face attribute.

In an embodiment, the at least one delivery object includes a plurality of delivery objects with at least two delivery objects corresponding to different face attributes, and the operations include: obtaining target delivery information for face attributes associated with the plurality of delivery objects; determining priorities of the plurality of delivery objects based on a plurality of sets of face attributes associated with the plurality of delivery objects; and delivering the target delivery information for the plurality of delivery objects, including one of: delivering the target delivery information for the plurality of delivery objects in sequence or in batches based on the priorities of the plurality of delivery objects, or delivering target delivery information for at least one of the plurality of delivery objects, where each of the at least one of the plurality of delivery objects has a higher priority than each of one or more other delivery objects among the plurality of delivery objects.

In an embodiment, the face attribute includes at least one of a gender, an age, or an expression, and the operations further include at least one of: if the face attribute includes the gender, determining that a female delivery object has a higher priority than a male delivery object, if the face attribute includes the age, determining that a delivery object with a younger age has a higher priority than a delivery object with an older age, or if the face attribute includes the expression, determining that a delivery object with a positive expression has a higher priority than a delivery object with a negative expression.

In an embodiment, the face attribute includes at least one of a total amount of payments or a number of payments, and the operations further include at least one of: if the face attribute includes the total amount of payments, determining that the at least one delivery object has a priority positively correlated with the total amount of payments, or if the face attribute includes the number of payments, determining that the at least one delivery object has a priority positively correlated with the number of payments.

Embodiments of the present disclosure provide a non-transitory computer-readable storage medium storing one or more programming instructions executable by at least one processor to perform operations including: acquiring a face image of at least one delivery object; determining a face attribute according to the face image, where a delivery object corresponds to a set of face attributes; obtaining target delivery information for the face attribute; and delivering the target delivery information for the face attribute.

In an embodiment, the face attribute includes a face identifier, and obtaining the target delivery information for the face attribute includes: determining to-be-delivered information and historical delivery information for the face identifier; and obtaining, from the to-be-delivered information, information other than the historical delivery information, at least part of which is used as the target delivery information for the face identifier.

In an embodiment, the face attribute includes a face identifier, and determining the face attribute according to the face image includes: obtaining, from a face image library, a reference face image with a highest similarity to a first face image involved in the face image; and if a similarity between the first face image and the reference face image is greater than a threshold, determining an identifier corresponding to the reference face image as the face identifier corresponding to the first face image.

In an embodiment, the operations further include: if the similarity between the first face image and the reference face image is no greater than the threshold, generating the face identifier corresponding to the first face image, and storing the face identifier corresponding to the first face image in the face image library in association with the first face image.

According to embodiments of the present disclosure, relevant information of a delivery object may be determined by using a face image of the delivery object, and may be used to select suitable delivery information for the delivery object for delivery. In this way, different or the same target delivery information may be selected for different delivery objects for delivery, making the information delivery more targeted and improving the flexibility and effect of the information delivery,

### BRIEF DESCRIPTION OF THE DRAWINGS

FIG. 1 is a flowchart illustrating a method for information delivery according to an embodiment of the present disclosure.

FIG. 2 is a schematic diagram illustrating an exemplary process for determining a face identifier according to an embodiment of the present disclosure.

FIG. 3 is a schematic diagram illustrating an exemplary process for information delivery according to an embodiment of the present disclosure.

FIG. 4 is a schematic structural diagram illustrating an apparatus for information delivery according to an embodiment of the present disclosure.

FIG. 5 is a schematic structural diagram illustrating an electronic device according to an embodiment of the present disclosure.

### DETAILED DESCRIPTION OF THE EMBODIMENTS

Embodiments of the present disclosure will be clearly and completely described below in conjunction with the accompanying drawings in the embodiments of the present disclosure.

At present, advertisement contents played on a terminal are usually manually pre-selected from a large number of advertisement contents, and, in the case of a plurality of advertisement contents selected, an order in which the plurality of advertisement contents are played is manually arranged, so as to repeat the information delivery on the terminal according to fixed advertisement contents and a fixed order in which they are played. However, the use of a fixed form of information delivery is less flexible and less effective in information push.

Embodiments of the present disclosure provide a method for information delivery, an execution subject of which may be an apparatus for information delivery. For example, the method for information delivery may be executed by a terminal device, a server or another electronic device. The terminal device may include user equipment (UE), a mobile device, a user terminal, a terminal, a cellular phone, a cordless phone, a personal digital assistant (PDA), a handheld device, a computing device, an in-vehicle device, a wearable device, and the like. In some possible implementations, the method for information delivery may be implemented by a processor calling computer-readable instructions stored in a memory.

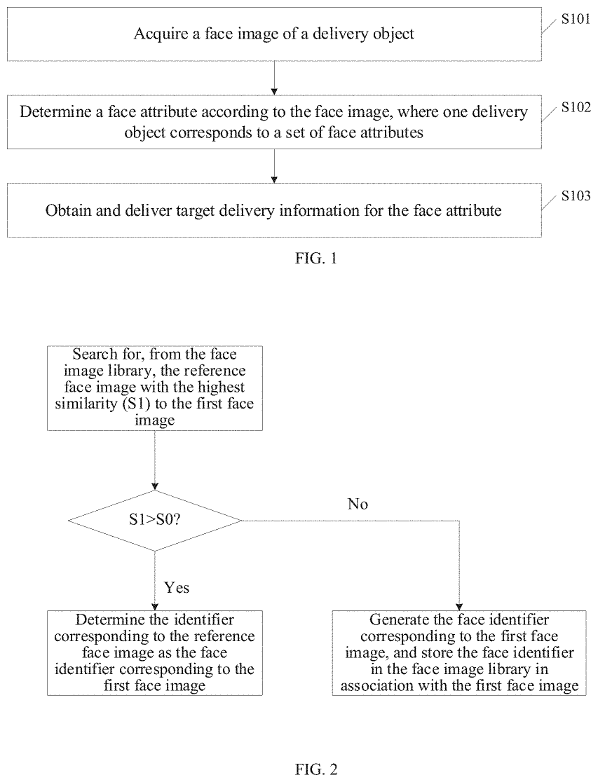

Embodiments of the present disclosure provide a method for information delivery. FIG. 1 is a flowchart illustrating a method for information delivery according to an embodiment of the present disclosure. As shown in FIG. 1, the method for information delivery mainly includes steps S101-S103.

At step S101, a face image of a delivery object is acquired.

In the embodiments of the present disclosure, the apparatus for information delivery may be configured to acquire the face image of the delivery object firstly. The apparatus for information delivery refers to a device that may be configured to deliver information to the delivery object. In the embodiments of the present disclosure, the apparatus for information delivery may be deployed in offline scenarios, such as shopping malls, supermarkets, and elevators, for example. The apparatus for information delivery may be in the form of an electronic billboard, an image delivery screen, a data display screen, and the like, which is not limited herein.

It should be noted that, in the embodiments of the present disclosure, the delivery object may be a person to whom the apparatus for information delivery may deliver information. The delivery object may include one or more delivery objects. The delivery object may be determined according to actual application scenarios and requirements, which is not limited in the embodiments of the present disclosure.

It should be noted that, in the embodiments of the present disclosure, the delivery object may be identified by the apparatus for information delivery or by a device such as a server or a cloud. The apparatus for information delivery or the device such as the server or the cloud may capture a video stream from which the delivery object may be identified.

It should be noted that, in the embodiments of the present disclosure, the apparatus for information delivery may identify, from the video stream, the delivery object to which the information may be delivered according to a specific algorithm and strategy. The specific algorithm and strategy used by the apparatus for information delivery to identify the delivery object may be selected according to the actual requirements, which is not limited in the embodiments of the present disclosure.

Exemplarily, in the embodiments of the present disclosure, the apparatus for information delivery may identify, from the captured video stream, a person who has been in front of the apparatus for information delivery for an extended period of time, for example, a person who has been in front of the apparatus for information delivery for a duration that exceeds a duration threshold, and identify the person as the delivery object.

It may be understood that, in the embodiments of the present disclosure, acquiring, by the apparatus for information delivery, the face image of the delivery object may include: acquiring, from the video stream involving the delivery object, the face image of the delivery object at any moment or at a particular moment. However, the apparatus for information delivery may acquire, from the video stream involving the delivery object, all face images of the delivery object, and select a face image with the best quality as the face image of the delivery object. The specific way in which the apparatus for information delivery acquires the face image of the delivery object is not limited in the embodiments of the present disclosure.

It should be noted that, in the embodiments of the present disclosure, the delivery object may include one or more delivery objects. In the case that the delivery object includes a plurality of delivery objects, the apparatus for information delivery may acquire a face image of each of the plurality of delivery objects.

In addition, the delivery object may be randomly selected or determined according to certain rules. For example, in the case that the delivery object is determined according to certain rules, the delivery object may be determined based on a combination of one or more of factors such as time and distances that a number of delivery objects stay in front of the apparatus for information delivery, which may be obtained by processing a face image of each of a number of delivery objects captured through an image capturing device such as a camera. The specific way in which the delivery object is determined is not limited in the embodiments of the present disclosure.

At step S102, a face attribute is determined according to the face image, where one delivery object corresponds to a set of face attributes.

In the embodiments of the present disclosure, the apparatus for information delivery, after acquiring the face image of the delivery object, is further configured to determine the face attribute according to the face image.

It should be noted that, in the embodiments of the present disclosure, the delivery object may include one or more delivery objects. In the case that the delivery object includes a plurality of delivery objects, the apparatus for information delivery may be configured to determine a respective set of face attributes according to the face image of each delivery object.

It should be noted that, in the embodiments of the present disclosure, the face attribute is used to characterize an identity feature of the corresponding delivery object. The face attribute may include at least one of a gender, an age, an expression, or a face identifier of the delivery object. In addition, in the case of the face identifier, the face attribute may further include a total amount of payments and/or the number of payments, etc., determined based on the face identifier. The face attribute is not particularly limited in the embodiments of the present disclosure.

In the embodiments of the present disclosure, the apparatus for information delivery, after acquiring the face image, may input the face image into a face attribute model, and calculate relevant attributes using the face attribute model, so as to output the face attribute such as the gender, the age, and the expression characterized by the face image. The face attribute model is not particularly limited in the embodiments of the present disclosure.

It should be noted that, in the embodiments of the present disclosure, the apparatus for information delivery may determine the face identifier based on a similarity comparison between face images, and the specific way in which the face identifier is determined will be described in detail later.

In the embodiments of the present disclosure, in the case of obtaining the face identifier, the apparatus for information delivery may use the face identifier to search for information associated with the delivery object, for example, the total amount of payments and/or the number of payments, etc., which may also he used as the face attribute.

At step S103, target delivery information for the face attribute is obtained and delivered.

In the embodiments of the present disclosure, the apparatus for information delivery, after determining the face attribute according to the face image, is further configured to obtain and deliver the target delivery information for the face attribute.

The delivery information may involve different contents in different application scenarios. For example, in the case that the apparatus for information delivery is deployed in hypermarkets, the delivery information may involve contents such as sales promotions of various brands in the hypermarkets. In the case that the apparatus for information delivery is deployed in real estate sales places, the delivery information may involve contents such as sales of each real estate. In the case that the apparatus for information delivery is deployed in public transportation such as buses and subways, the delivery information may involve advertising contents such as promotional information of manufacturers cooperating with the public transportation. The target delivery information refers to contents involved in the delivery information that are determined to be delivered by the apparatus for information delivery.

It should be noted that, in the embodiments of the present disclosure, the apparatus for information delivery may select matching information from a large number of deliverable information as the target delivery information based on specific relevant values of the face attribute, and deliver the target delivery information.

It should be noted that, in the embodiments of the present disclosure, one delivery object may correspond to a set of face attributes, thus the apparatus for information delivery may, for each delivery object, determine and deliver respective target delivery information by using a respective set of face attributes.

It may be understood that, in the embodiments of the present disclosure, the apparatus for information delivery may select the delivery information for the delivery object from a delivery information library based on a corresponding set of face attributes in accordance with a predetermined information selection strategy, so as to obtain a corresponding set of target delivery information.

In the embodiments of the present disclosure, each set of face attributes may include the gender, age, expression, total amount of payments and total number of payments of the respective delivery object, and the predetermined information selection strategy may include: cosmetics for women, and sports for men; trendy goods for young people, high-quality goods for middle-aged people, and practical goods for old people; high-priced goods for positive expressions, and affordable goods for negative expressions; and luxury goods such as high-priced goods for high consumption, and cost-effective goods such as low-priced goods for low consumption, etc.

It may be understood that, in the embodiments of the present disclosure, the apparatus for information delivery may be configured to obtain the target delivery information for the face attribute according to a specific rule or strategy. In addition, the apparatus for information delivery may be configured to deliver the target delivery information in a specific delivery way, which is not limited in the embodiments of the present disclosure.

It may be understood that, in the embodiments of the present disclosure, relevant information of a delivery object may be determined by using a face image of the delivery object, and may be used to select suitable delivery information for the delivery object for delivery. In this way, different or the same target delivery information may be selected for different delivery objects for delivery, making the information delivery more targeted and improving the flexibility and effect of the information delivery.

Optionally, in the embodiments of the present disclosure, the face attribute may include a face identifier, and obtaining, by the apparatus for information delivery, the target delivery information for the face attribute may include: determining to-be-delivered information and historical delivery information for the face identifier; and obtaining, from the to-be-delivered information, information other than the historical delivery information.

It should be noted that, in the embodiments of the present disclosure, the face attribute may include the face identifier, and the apparatus for information delivery may not only determine the to-be-delivered information for the face identifier, but also obtain the historical delivery information for the face identifier by using a correspondence between different face identifiers and historical delivery information, so as to filter out the historical delivery information from the to-be-delivered information, and use at least part of the remaining information as the target delivery information.

It should be noted that, in the embodiments of the present disclosure, the historical delivery information may include all information that has been delivered to the delivery object by the apparatus for information delivery. However, the historical delivery information may also include information that has been delivered to the delivery object by the apparatus for information delivery within a historical period of time. For example, the historical delivery information may include information that has been delivered to the delivery object within a month. The historical delivery information is not particularly limited in the embodiments of the present disclosure.

It may be understood that, in the embodiments of the present disclosure, the apparatus for information delivery may filter out the historical delivery information from the determined to-be-delivered information, thereby avoiding frequent and repeated delivery of the same information to the delivery object and improving the effectiveness of the information delivery.

Optionally, in the embodiments of the present disclosure, the face attribute may include a face identifier, and determining, by the apparatus for information delivery, the face attribute according to the face image may include: obtaining, from a face image library, a reference face image with the highest similarity to a first face image involved in the face image; and in response to the similarity between the first face image and the reference face image being greater than a threshold, determining an identifier corresponding to the reference face image as a face identifier corresponding to the first face image. The threshold may have a preset value, which may be determined according to at least one of factors such as a resolution of an image capturing device (which may be deployed around the apparatus for information delivery, or deployed on the apparatus for information delivery, etc.), a processing power of a device that performs the similarity comparison, and occupancy of resources. The value of the threshold is not limited in the embodiments of the present disclosure.

It should be noted that, in the embodiments of the present disclosure, the first face image may be one of face images acquired by the apparatus for information delivery. The first face image is not particularly limited in the embodiments of the present disclosure.

It should be noted that, in the embodiments of the present disclosure, the apparatus for information delivery may perform face matching between face images in the face image library and the first face image by using a preset face matching algorithm, such that a face image with the highest similarity to the first face image may be selected from the face image library and determined as the reference face image.

It should be noted that, in the embodiments of the present disclosure, different face images may be stored in the face image library, and each face image may be stored with a respective identifier. The face image library is not particularly limited in the embodiments of the present disclosure.

It should be noted that, in the embodiments of the present disclosure, the preset face matching algorithm may be configured to perform a comparison between face image features to determine a degree of similarity therebetween. The preset face matching algorithm may be selected according to the actual requirements, which is not limited in the embodiments of the present disclosure.

It should be noted that, in the embodiments of the present disclosure, the threshold may be stored in the apparatus for information delivery for similarity comparison. The threshold may be preset according to the actual requirements, which is not particularly limited in the embodiments of the present disclosure.

Exemplarily, in the embodiments of the present disclosure, the apparatus for information delivery may search for, from the face image library, the reference face image with the highest similarity to the first face image by using the preset face matching algorithm, where the similarity between the first face image and the reference face image is 80%. If the threshold has a value of 75%, the similarity between the first face image and the reference face image is greater than the threshold. Therefore, the apparatus for information delivery may determine an identifier ID1 corresponding to the reference face image as the face identifier corresponding to the first face image.

It may be understood that, in the embodiments of the present disclosure, the apparatus for information delivery may first obtain, from the face image library, the reference face image with the highest similarity to the first face image. Then, in the case that the similarity between the first face image and the reference face image is relatively high, that is, greater than the threshold, it indicates that the first face image and the reference face image actually belong to the same delivery object. Therefore, the identifier corresponding to the reference face image may be determined as the face identifier corresponding to the first face image, such that the face identifier corresponding to the first face image may be obtained accurately, which may avoid misidentification due to direct use of the identifier corresponding to the reference face image.

Optionally, in the embodiments of the present disclosure, the apparatus for information delivery may be further configured to: in response to the similarity between the first face image and the reference face image being not greater than the threshold, generate the face identifier corresponding to the first face image, and store the face identifier corresponding to the first face image in the face image library in association with the first face image.

Exemplarily, in the embodiments of the present disclosure, the apparatus for information delivery may search for, from the face image library, the reference face image with the highest similarity to the first face image by using the preset face matching algorithm, where the similarity between the first face image and the reference face image is 60%. If the threshold has a value of 85%, the similarity between the first face image and the reference face image is less than the threshold. Therefore, the apparatus for information delivery may generate the face identifier ID2 corresponding to the first face image, and store the face identifier ID2 in the face image library in association with the first face image.

It should be noted that, in the embodiments of the present disclosure, in the case that the similarity between the first face image and the reference face image is not greater than the threshold, that is, the similarity between the first face image and the reference face image is relatively low, it indicates that the first face image and the reference face image may not actually belong to the same delivery object, and the reference face image is an image in the face image library which has the highest similarity to the first face image. That is to say, there is no face image in the face image library that belongs to the same delivery object as the first face image. Therefore, the apparatus for information delivery may generate the face identifier corresponding to the first face image, and store the face identifier and the first face image in the face image library.

It may be understood that, in the embodiments of the present disclosure, the apparatus for information delivery may generate the face identifier corresponding to the first face image, and store the generated face identifier in the face image library in association with the first face image, such that the corresponding face identifier may be obtained for the same delivery object in subsequent information delivery, so as to obtain subsequent delivery information, which provides a way to obtain information.

FIG. 2 is a schematic diagram illustrating an exemplary process for determining a face identifier according to an embodiment of the present disclosure. As shown in FIG. 2, the apparatus for information delivery may search for, from the face image library, the reference face image with the highest similarity to the first face image by using the preset face matching algorithm, and then compare the similarity S1 between the first face image and the reference face image with the threshold S0. If S1 is greater than S0, it indicates that the first face image and the reference face image correspond to the same delivery object, which is actually the same person. Therefore, the identifier corresponding to the reference face image may be determined as the face identifier corresponding to the first face image. If S1 is not greater than S0, it indicates that the first face image and the reference face image correspond to different delivery objects, which are actually different persons. Therefore, the apparatus for information delivery may create the face identifier corresponding to the first face image, and store the face identifier in the face image library in association with the first face image.

Optionally, in the embodiments of the present disclosure, after delivering the target delivery information for the face attribute, the apparatus for information delivery may be further configured to: determining and storing the target delivery information for the face attribute as historical delivery information for the face attribute.

It should be noted that, in the embodiments of the present disclosure, one delivery object may correspond to a set of face attributes, and the target delivery information is determined according to the face attribute. Therefore, the apparatus for information delivery may determine and store the target delivery information as the historical delivery information for the face attribute, which actually stores the historical delivery information corresponding to the delivery object.

It should be noted that, in the embodiments of the present disclosure, each set of face attributes may correspond to respective target delivery information, and the apparatus for information delivery may store the respective target delivery information as respective historical delivery information for each set of face attributes.

It may be understood that, in the embodiments of the present disclosure, the apparatus for information delivery may determine and store the target delivery information for the face attribute as the historical delivery information for the face attribute, such that in the case that the same delivery object and the corresponding face attribute are obtained during the subsequent information delivery, the historical delivery information may be filtered out when selecting the corresponding target delivery information, providing a basis for information selection to avoid repeated delivery of the same information.

Optionally, in the embodiments of the present disclosure, in the case that the delivery object includes a plurality of delivery objects with at least two of the delivery objects corresponding to different face attributes, after obtaining the target delivery information for the face attribute, the apparatus for information delivery may be further configured to: determine priorities of the plurality of delivery objects based on a plurality of sets of face attributes; and delivering the target delivery information for the face attribute may include: delivering target delivery information for the plurality of delivery objects in sequence or in batches based on the priorities of the plurality of delivery objects; or delivering target delivery information for at least some of the plurality of delivery objects, where each of the at least some delivery objects has a higher priority than that of each of delivery objects other than the at least some delivery objects among the plurality of delivery objects.

It should be noted that, in the embodiments of the present disclosure, in the case that the delivery object includes a plurality of delivery objects with at least two of the delivery objects corresponding to different face attributes, the apparatus for information delivery may use the plurality of sets of obtained face attributes to determine the priorities of the respective delivery objects, such that the target delivery information may be delivered subsequently based on the priorities.

In the embodiments of the present disclosure, the apparatus for information delivery may first deliver, on a delivery screen, target delivery information corresponding to the delivery object with the highest priority, and then target delivery information corresponding to the delivery object with the next highest priority, that is, the apparatus for information delivery may deliver target delivery information corresponding to the delivery objects in order of priority from highest to lowest. This enables dynamic display of different delivery information in a limited display area of the delivery screen by prioritizing target delivery objects, which makes each display stage more targeted and takes into consideration each delivery object throughout the information delivery process.

In addition, the apparatus for information delivery may also divide the delivery objects according to priority, and simultaneously deliver target delivery information corresponding to the same batch of delivery objects in different areas of the delivery screen. For example, in the case of simultaneous delivery of target delivery information corresponding to a batch of delivery objects, the limited delivery screen may be divided into areas according to a priority of each delivery object in the batch, such that an area that is easy to follow and convenient for the delivery object to focus on may be allocated to the delivery object with a higher priority, and target delivery information corresponding to the delivery object with the higher priority may be displayed in this area. For example, target delivery information corresponding to the delivery object in the batch with the highest priority may be delivered in a middle area of the delivery screen, while target delivery information corresponding to the delivery object in the batch with a lower priority may be delivered in a corner area of the delivery screen. In this way, visible areas may be fully utilized in the limited display area of the delivery screen, so as to display the target delivery information for multiple delivery objects in an allocation manner such as that described above.

In the embodiments of the present disclosure, the apparatus for information delivery may also select at least some of the plurality of delivery objects with higher priorities based on the priorities of the plurality of delivery objects, and only deliver target delivery information corresponding to the at least some delivery objects. The number of the at least some delivery objects may be preset according to the actual requirements, for example, in conjunction with a size of visible areas of the apparatus for information delivery, network conditions, and the like, which is not particularly limited in the embodiments of the present disclosure.

It should be noted that, in the embodiments of the present disclosure, when delivering the target delivery information, the apparatus for information delivery may also deliver corresponding target delivery information in a corresponding area of the delivery screen according to a position of the delivery object in front of the delivery screen.

It may be understood that, in the embodiments of the present disclosure, in the case of obtaining a plurality of delivery objects, the apparatus for information delivery may use the corresponding face attributes to determine the priorities of the plurality of delivery objects for information delivery, so as to support delivery scenarios where a plurality of delivery objects appear and improve the coverage of information delivery.

Optionally, in the embodiments of the present disclosure, the face attribute may include at least one of a gender, an age, or an expression; and when the face attribute includes the gender, a female delivery object has a higher priority than that of a male delivery object; and/or when the face attribute includes the age, the delivery object has a priority negatively correlated with the age; and/or when the face attribute includes the expression, a delivery object with a positive expression has a higher priority than that of a delivery object with a negative expression.

Exemplarily, in the embodiments of the present disclosure, the apparatus for information delivery may acquire a total of two different delivery objects 1 and 2, where a set of face attributes for the delivery object 1 includes the gender of the delivery object 1 as female, and a set of face attributes for the delivery object 2 includes the gender of the delivery object 2 as male. A set of target delivery information corresponding to the delivery object 1 is denoted as M1, and a set of target delivery information corresponding to the delivery object 2 is denoted as M2. Based on the rule that the female delivery object has a higher priority than that of the male delivery object, the apparatus for information delivery may determine that the priority of the delivery object 1 is higher than the priority of the delivery object 2.

It may be understood that, in the embodiments of the present disclosure, consumption power of women is usually higher than that of men, the consumption power of young people is usually higher than that of old people, and consumption possibility of people with positive expressions is usually higher than that of people with negative expressions. Therefore, the apparatus for information delivery may determine the priorities of the delivery targets based on at least one of the gender, age or expression, such that delivery of corresponding target delivery information may be prioritized for delivery targets with higher consumption power and higher consumption possibility, which improves the effectiveness of information delivery.

Optionally, in the embodiments of the present disclosure, the face attribute may include at least one of a total amount of payments or the number of payments, and when the face attribute includes the total amount of payments, the delivery object has a priority positively correlated with the total amount of payments; and/or when the face attribute includes the number of payments, the delivery object has a priority positively correlated with the number of payments.

It should be noted that, in the embodiments of the present disclosure, when the obtained face attribute includes the face identifier, the apparatus for information delivery may use the face identifier to search for corresponding associated information as part of the face attribute, such as, for example, the total amount of payments, the number of payments, and the like. Therefore, the apparatus for information delivery may also use the total amount of payments and/or the number of payments to determine the priorities of the delivery objects.

It may be understood that, in the embodiments of the present disclosure, the higher the total amount of payments and/or the number of payments, the stronger the consumption power of the corresponding delivery object, the priority of which may thus be set higher such that subsequent delivery of corresponding target delivery information may be prioritized, which improves the effectiveness of information delivery.

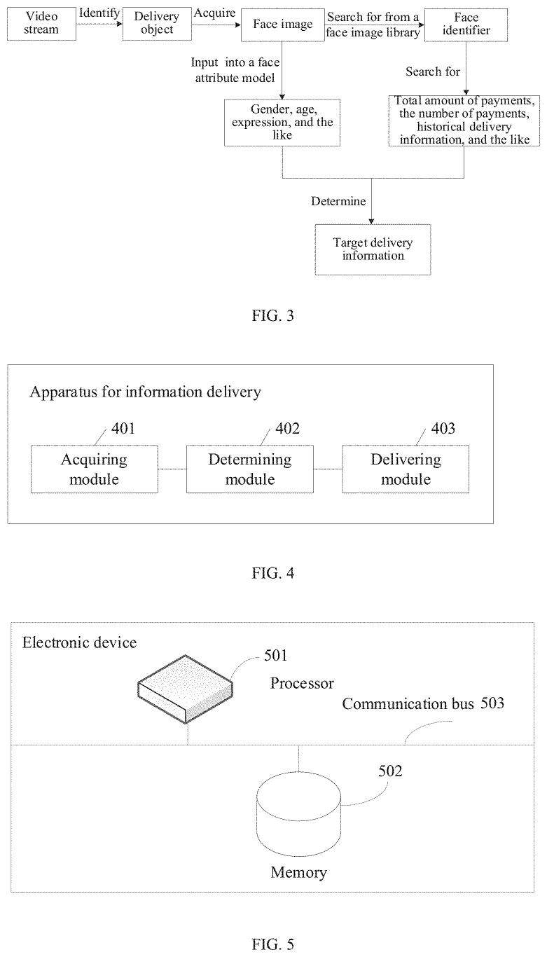

FIG. 3 is a schematic diagram illustrating an exemplary process for information delivery according to an embodiment of the present disclosure. As shown in FIG. 3, the apparatus for information delivery may identify a delivery object from a video stream, acquire a face image of the delivery object, and then determine a gender, age, expression, total amount of payments, total number of payments, and historical delivery information for the delivery object based on the face image of the delivery object, so as to select corresponding target delivery information from a delivery information library by using these information.

Embodiments of the present disclosure provide an apparatus for information delivery. FIG. 4 is a schematic structural diagram illustrating an apparatus for information delivery according to an embodiment of the present disclosure. As shown in FIG. 4, the apparatus for information delivery includes an acquiring module 401, a determining module 402, and a delivering module 403.

The acquiring module 401 is configured to acquire a face image of a delivery object.

The determining module 402 is configured to determine a face attribute according to the face image, where one delivery object corresponds to a set of face attributes.

The delivering module 403 is configured to obtain and deliver target delivery information for the face attribute.

Optionally, the face attribute includes a face identifier, and the delivering module 403 is further configured to: determine to-be-delivered information and historical delivery information for the face identifier; and obtain, from the to-be-delivered information, information other than the historical delivery information.

Optionally, the face attribute includes a face identifier, and the determining module 402 is further configured to: obtain, from a face image library, a reference face image with the highest similarity to a first face image involved in the face image; and in response to the similarity between the first face image and the reference face image being greater than a threshold, determine an identifier corresponding to the reference face image as a face identifier corresponding to the first face image.

Optionally, the determining module 402 is further configured to: in response to the similarity between the first face image and the reference face image being not greater than the threshold, generate the face identifier corresponding to the first face image, and store the face identifier corresponding to the first face image in the face image library in association with the first face image.

Optionally, the determining module 402 is further configured to: determine and store the target delivery information for the face attribute as historical delivery information for the face attribute.

Optionally, in the case that the delivery object includes a plurality of delivery objects with at least two of the delivery objects corresponding to different face attributes, the determining module 402 is further configured to: determine priorities of the plurality of delivery objects based on a plurality of sets of face attributes; and the delivering module 403 is further configured to: deliver target delivery information for the plurality of delivery objects in sequence or in batches based on the priorities of the plurality of delivery objects; or deliver target delivery information for at least some of the plurality of delivery objects, where each of the at least some delivery objects has a higher priority than that of each of delivery objects other than the at least some delivery objects among the plurality of delivery objects.

Optionally, the face attribute includes at least one of a gender, an age, or an expression; and when the face attribute includes the gender, a female delivery object has a higher priority than that of a male delivery object; and/or when the face attribute includes the age, the delivery object has a priority negatively correlated with the age; and/or when the face attribute includes the expression, a delivery object with a positive expression has a higher priority than that of a delivery object with a negative expression.

Optionally, the face attribute includes at least one of a total amount of payments or the number of payments; and when the face attribute includes the total amount of payments, the delivery object has a priority positively correlated with the total amount of payments; and/or when the face attribute includes the number of payments, the delivery object has a priority positively correlated with the number of payments.

Embodiments of the present disclosure provide an electronic device. FIG. 5 is a schematic structural diagram illustrating an electronic device according to an embodiment of the present disclosure. As shown in FIG. 5, the electronic device includes a processor 501, a memory 502, and a communication bus 503.

The communication bus 503 is configured to implement connection and communication between the processor 501 and the memory 502.

The processor 501 is configured to execute an information delivery program stored in the memory 502 to perform the above method for information delivery.

According to embodiments of the present disclosure, relevant information of a delivery object may be determined by using a face image of the delivery object, and may be used to select suitable delivery information for the delivery object for delivery. In this way, different or the same target delivery information may be selected for different delivery objects for delivery, making the information delivery more targeted and improving the flexibility and effect of the information delivery.

Embodiments of the present disclosure further provide a computer-readable storage medium in which one or more programs are stored. The one or more programs are executable by one or more processors to perform the above method for information delivery. The computer-readable storage medium may include a volatile memory such as a Random-Access Memory (RAM), a non-volatile memory such as a Read-Only Memory (ROM), a flash memory, a Hard Disk Drive (HDD) or a Solid-State Drive (SSD), or an electronic device including one or any combination of the above memories, such as a mobile phone, a computer, a tablet device, and a personal digital assistant.

Embodiments of the present disclosure further provide a computer program, which, when executed by a processor, causes the processor to perform the above method for information delivery.

Those skilled in the art should understand that embodiments of the present disclosure may be provided as methods, systems, or computer program products. Accordingly, the present disclosure may take the form of hardware embodiments, software embodiments, or embodiments combining software and hardware aspects. Further, the present disclosure may take the form of a computer program product implemented in one or more computer-usable storage media (including but not limited to, disk storage, optical storage, and the like) that contain computer-usable program codes therein.

The present disclosure is described with reference to flowcharts and/or block diagrams of methods, devices (systems), and computer program products according to embodiments of the present disclosure. It should be understood that each of processes and/or blocks in the flowcharts and/or block diagrams, and a combination of the processes and/or blocks in the flowcharts and/or block diagrams, may he implemented by computer program instructions. These computer program instructions may be provided to a processor of a general-purpose computer, a special-purpose computer, an embedded processor, or other programmable signal processing device to produce a machine such that the instructions executed by the processor of the computer or other programmable signal processing device produce an apparatus for implementing functions specified in one or more processes in the flowcharts and/or one or more blocks in the block diagrams.

These computer program instructions may also be stored in a computer-readable memory capable of directing a computer or other programmable signal processing device to operate in a particular manner, such that the instructions stored in the computer-readable memory produce an article of manufacture including an instruction apparatus that implements functions specified in one or more processes in the flowcharts and/or one or more blocks in the block diagrams.

These computer program instructions may also be loaded onto a computer or other programmable signal processing device such that a series of operating steps are executed on the computer or other programmable signal processing device to produce a computer-implemented processing such that the instructions executed on the computer or other programmable signal processing device provide steps for implementing functions specified in one or more processes in the flowcharts and/or one or more blocks in the block diagrams.

The foregoing are only preferred embodiments of the present disclosure, and are not intended to limit the scope of protection of the present disclosure.

1. A computer-implemented method for information delivery, comprising:
acquiring a face image of at least one deliver object;
determining a face attribute according to the face image, wherein a delivery object corresponds to a set of face attributes;
obtaining target delivery information for the face attribute; and
delivering the target deliver information for the face attribute.

2. The computer-implemented method of claim 1, wherein the face attribute comprises a face identifier, and
wherein obtaining the target delivery information for the face attribute comprises:
determining to-be-delivered information and historical delivery information for the face identifier; and
obtaining, from the to-be-delivered information, information other than the historical delivery information, at least part of which is used as the target delivery information for the face identifier.

3. The computer-implemented method of claim 1, wherein the face attribute comprises a face identifier, and
wherein determining the face attribute according to the face image comprises:
obtaining, from a face image library, a reference face image with a highest similarity to a first face image involved in the face image; and
if a similarity between the first face image and the reference face image is greater than a threshold, determining an identifier corresponding to the reference face image as the face identifier corresponding to the first face image.

4. The computer-implemented method of claim 3, further comprising:
if the similarity between the first face image and the reference face image is no greater than the threshold, generating the face identifier corresponding to the first face image, and storing the face identifier corresponding to the first face image in the face image library in association with the first face image.

5. The computer-implemented method of claim 1, further comprising:
after delivering the target delivery information for the face attribute, determining and storing the target delivery information for the face attribute as historical delivery information for the face attribute.

6. The computer-implemented method of claim 1, wherein the at least one delivery object comprises a plurality of delivery objects with at least two delivery objects corresponding to different face attributes, and
wherein the computer-implemented method comprises:
obtaining target delivery information for face attributes associated with the plurality of delivery objects;
determining priorities of the plurality of delivery objects based on a plurality of sets of face attributes associated with the plurality of delivery objects and
delivering the target delivery information for the plurality of delivery objects, comprising one of
delivering the target delivery information for the plurality of delivery objects in sequence or in batches based on the priorities of the plurality of delivery objects, or
delivering target delivery information for at least one of the plurality of delivery objects, wherein each of the at least one of the plurality of delivery objects has a higher priority than each of one or more other delivery objects among the plurality of delivery objects.

7. The computer-implemented method of claim 1, wherein the face attribute comprises at least one of a gender, an age, or an expression, and
wherein the computer-implemented method further comprises at least one of:
if the face attribute comprises the gender, determining that a female delivery object has a higher priority than a male delivery object,
if the face attribute comprises the age, determining that a delivery object with a younger age has a higher priority than a delivery object with an older age, or
if the face attribute comprises the expression, determining that a delivery object with a positive expression has a higher priority than a delivery object with a negative expression.

8. The computer-implemented method of claim 1, wherein the face attribute comprises at least one of a total amount of payments or a number of payments, and
wherein the computer-implemented method further comprises at least one of:
if the face attribute comprises the total amount of payments, determining that the at least one delivery object has a priority positively correlated with the total amount of payments, or
if the face attribute comprises the number of payments, determining that the at least one delivery object has a priority positively correlated with the number of payments.

9. An electronic device comprising:
at least one processor;
at least one memory; and
a communication bus configured to implement connection and communication between the at least one processor and the at least one memory,
wherein the at least one memory is coupled to the at least one processor and stores programming instructions for execution by the at least one processor to perform operations comprising:
acquiring a face image of at least one delivery object;
determining a face attribute according to the face image, wherein a delivery object corresponds to a set of face attributes;
obtaining target delivery information for the face attribute; and
delivering the target delivery information for the face attribute.

10. The electronic device of claim 9, wherein the face attribute comprises a face identifier, and
wherein obtaining the target delivery information for the face attribute comprises:
determining to-be-delivered information and historical delivery information for the face identifier; and
obtaining, from the to-be-delivered information, information other than the historical delivery information, at least part of which is used as the target delivery information for the face identifier.

11. The electronic device of claim 9, wherein the face attribute comprises a face identifier, and
wherein determining the face attribute according to the face image comprises:
obtaining, from a face image library, a reference face image with a highest similarity to a first face image involved in the face image; and
if a similarity between the first face image and the reference face image is greater than a threshold, determining an identifier corresponding to the reference face image as the face identifier corresponding to the first face image.

12. The electronic device of claim 11, wherein the operations further comprise:
if the similarity between the first face image and the reference face image is no greater than the threshold, generating the face identifier corresponding to the first face image, and storing the face identifier corresponding to the first face image in the face image library in association with the first face image.

13. The electronic device of claim 9, wherein the operations further comprise:
after delivering the target delivery information for the face attribute, determining and storing the target delivery information for the face attribute as historical delivery information for the face attribute,

14. The electronic device of claim 9, wherein the at least one delivery object comprises a plurality of delivery objects with at least two delivery objects corresponding to different face attributes, and
wherein the operations comprise:
obtaining target delivery information attributes associated with the plurality of delivery objects;
determining priorities of the plurality of delivery objects based on a plurality of sets of face attributes associated with the plurality of delivery objects; and
delivering the target delivery information for the plurality of delivery objects, comprising one of:
delivering the target delivery information for the plurality of delivery objects in sequence or in batches based on the priorities of the plurality of delivery objects, or
delivering target delivery information for at least one of the plurality of delivery objects, wherein each of the at least one of the plurality of delivery objects has a higher priority than each of one or more other delivery objects among the plurality of delivery objects.

15. The electronic device of claim 9, wherein the face attribute comprises at least one of a. gender, an age, or an expression, and
wherein the operations further comprise at least one of:
if the face attribute comprises the gender, determining that a female delivery object has a higher priority than a male delivery object,
if the face attribute comprises the age, determining that a delivery object with a younger age has a higher priority than a delivery object with an older age, or
if the face attribute comprises the expression, determining that a delivery object with a positive expression has a higher priority than a delivery object with a negative expression.

16. The electronic device of claim 9, wherein the face attribute comprises at least one of a total amount of payments or a number of payments, and
wherein the operations further comprise at least one of:
if the face attribute comprises the total amount of payments, determining, that the at least one delivery object has a priority positively correlated with the total amount of payments, or
if the face attribute comprises the number of payments, determining that the at least one delivery object has a priority positively correlated with the number of payments.

17. A non-transitory computer-readable storage medium storing one or more programming instructions executable by at least one processor to perform operations comprising:
acquiring a face image of at least one delivery object;
determining a face attribute according to the face image, wherein a delivery object corresponds to a set of face attributes;
obtaining target delivery information for the face attribute; and
delivering the target delivery information for the face attribute.

18. The non-transitory computer-readable storage medium of claim 17, wherein the face attribute comprises a face identifier, and
wherein obtaining the target delivery information for the face attribute comprises:
determining to-be-delivered information and historical delivery information for the face identifier; and
obtaining, from the to-be-delivered information, information other than the historical delivery information, at least part of which is used as the target delivery information for the face identifier.

19. The non-transitory computer-readable storage medium of claim 17, wherein the face attribute comprises a face identifier, and
wherein determining the face attribute according to the face image comprises:
obtaining, from a face image library, a reference face image with a highest similarity to a first face image involved in the face image; and
if a similarity between the first face image and the reference face image is greater than a threshold, determining an identifier corresponding to the reference face image as the face identifier corresponding to the first face image.

20. The non-transitory computer-readable storage medium of claim 19, wherein the operations further comprise:
if the similarity between the first face image and the reference face image is no greater than the threshold, generating the face identifier corresponding to the first face image, and storing the face identifier corresponding to the first face image in the face image library in association with the first face image.
